(19) United States
(12) Patent Application Publication
(10) Pub. No.: US 2015/0289498 A1
(43) Pub. Date: Oct. 15, 2015

(54) Tree Stand

(71) Applicant: James F. Boekeloo, Hennepin, IL (US)

(72) Inventor: James F. Boekeloo, Hennepin, IL (US)

(21) Appl. No.: 14/618,032

(22) Filed: Feb. 10, 2015

Related U.S. Application Data
(60) Provisional application No. 61/979,574, filed on Apr. 15, 2014.

(51) Int. Cl. A01M 31/02; E06C 1/39

(52) U.S. Cl. CPC A01M 31/02; E06C 1/39

(57) ABSTRACT

A portable tree stand assembly for installation and removal onto a tree is described. The assembly includes moveable securing members, which open and close around the tree trunk facilitating safe and easy installation and removal of the tree stand, and are operable from the ground by a user. The disclosed stand may include detachable ladder sections and may be compactable to operate as a gear/game cart when not in use as a stand.

### TECHNICAL FIELD OF THE INVENTION

The present invention relates generally to tree stands and more specifically, to a portable tree stand assembly for use in hunting, for wildlife and bird watching, and for other observation activities, which can be completely secured to the tree from the ground.

### BACKGROUND OF THE INVENTION

Tree stands are well-known and are commonly used by hunters. Tree stands allow a hunter to more easily survey an area and also keep the hunter at a height such that it is harder for an animal to catch the hunter's scent. Additionally, tree stands can be used by other outdoor enthusiasts, such as wildlife photographers and bird watchers.

Existing tree stands typically include a chain or strap to secure the device to a tree. The chain or strap extends around the perimeter of the tree trunk, the ends being securely fastened to the tree stand. Once the user climbs the tree and places chain or strap around the tree trunk it can be pulled tight, thereby securing the tree stand to tree trunks of varying thickness. Tree stands are typically positioned eight to sixteen feet above the ground, with factors such as cover provided by trees in the area and habits of the game animal being hunted, among other factors, determining the precise height at which a hunter will place a stand. A ladder is then used to reach the stand once it is in place, or it may be attached to the stand.

The use of chains and/or straps to secure tree stands can be difficult to secure around the trunk. Additionally, traditional tree stands require that the user climb the tree first carrying the tree stand, in order to secure the chains or straps to the trunk. Using bolts or other securing attachments may penetrate the living bark of the tree, injuring the tree and rendering it more susceptible to insect infestation or diseases.

Further, the dangers in climbing a tree to a desired height to secure a tree stand, and getting on a tree stand positioned 15-20 feet above the ground are well-documented. Falls by users trying to reach around a tree to secure a stand or falling from a collapsed, improperly secured tree stand have become commonplace in the hunting industry.

Therefore, the present disclosure provides a portable tree stand assembly, which is easy to use, install and remove by a single user positioned on the ground, without causing damage to the tree trunk.

### SUMMARY OF THE INVENTION

Generally speaking, the present safety system is particularly for use with a portable tree stand to allow for quick assembly and safe attachment to and removal from a vertical support, such as a tree trunk, by a single user standing on the ground.

In one embodiment, the disclosed tree stand includes a platform having a front, back and opposing sides, and the safety system attached thereto. The safety system includes a rotatable shaft secured to the platform, a first movable securing member moveably connected to the rotatable shaft via linkage, a second movable securing member moveably connected to the shaft, via linkage, opposite to the first securing member, and a gear attached to the rotatable shaft. When the gear rotates the shaft in a first direction, the first and second securing members are pivoted outward away from each other, and when the gear rotates the shaft in a second direction, the first and second securing members are pivoted inward toward each other.

In another embodiment, the portable tree stand assembly is compactable and includes a first platform, the safety system attached to the first platform, and a second platform which connects to the first platform via connecting rails, wherein the second platform can be disconnected and extended from the first platform or connected to the first platform in a compact, portable configuration. The safety system works as in the previous embodiment.

Additionally, foldable ladder sections may attach to and detach from the second platform to provide climbing access to the first platform when the stand is attached to a vertical support, such as a tree. Optionally, detachable wheel mounts may connect to the compacted configuration at an end of the first platform to provide rolling mobility of the tree-stand.

These and other advantages will be more readily apparent from a review of the following detailed description and the appended drawings referenced therein.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of an embodiment of a tree-stand assembly in use in accordance with the present disclosure;

FIG. 2 is a top view of an embodiment of the tree-stand assembly in a compact configuration for storage or transport;

FIG. 3 is a side view of the tree stand assembly as shown in FIG. 2;

FIG. 4 is a top view of a movable securing member with a close up view of a toothed section of the securing member;

FIG. 5 is a top view of a threaded shaft as shown in FIG. 2;

FIG. 6 is a front view of a traveler of the linkage as shown in FIG. 2;

FIG. 7 is a series of view of an embodiment of the gear/pulley used to operate the securing members of the disclosed tree-stand;

FIG. 8 is a top view of a linking arm of the linkage as shown in FIG. 2;

FIG. 9 is a top view of an embodiment of the present tree-stand assembly in a disengaged or open position;

FIG. 10 is a top view of an embodiment of the present tree-stand assembly in an engaged or closed position;

FIG. 11 is a perspective view of a compactable embodiment of the present tree-stand in an open (i.e., non-compacted) configuration;

FIG. 12 is top view of the embodiment of the tree-stand of FIG. 11;

FIG. 13 is a perspective view of the compactable tree-stand of FIG. 11 including connected ladder sections;

FIG. 14 is a top view of the tree-stand of FIG. 13;

FIG. 15 is a perspective view of the compactable tree-stand of FIG. 11 in a compact configuration;

FIG. 16 is a bottom view of the embodiment of FIG. 15; and

FIG. 17 is a side view of the embodiment of FIG. 15.

### DETAILED DESCRIPTION OF PREFERRED EMBODIMENT

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

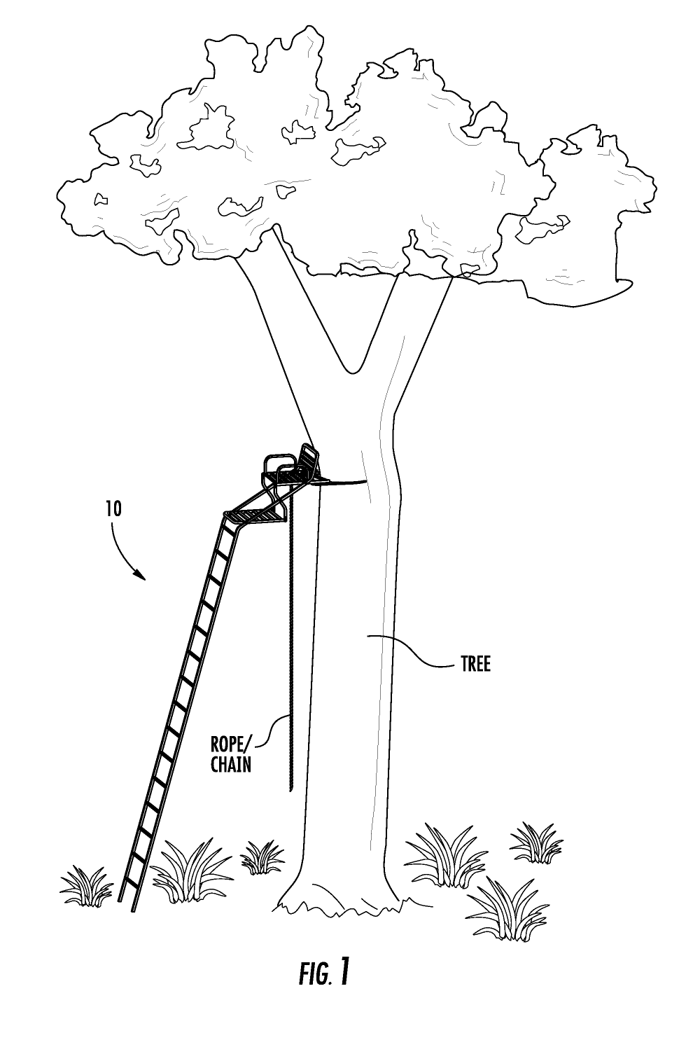

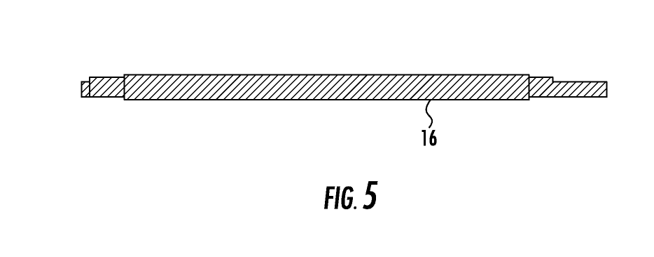

Referring to FIGS. 1-17, there are illustrated embodiments of a tree stand assembly 10 including a safety system 12 for attaching the stand to a vertical support, e.g., a tree. Because the stand 10 is intended to support at least one person for an extended period of time, it is important that the stand be capable of easy and secure attachment to a tree trunk. In addition, it is advantageous that the securing means used for the stand makes the stand easily removable and foldable for portability. Finally, the present tree stand assembly 10 provides for installation of the stand by a single user positioned on the ground, thereby avoiding the potentially awkward initial climb up a ladder carrying the tree stand to secure it in the tree.

As shown in FIG. 1, the tree stand assembly 10 is designed for installation at a desired height on a tree trunk. The stand can then be used for hunting, for wildlife and bird observation, for photography, and many other outdoor activities. For example, tree stands were recently used for observation of athletic competitions during the 2012 Sochi Winter Olympics.

Installation of typical tree stands usually requires a user to climb a ladder placed against a suitable tree up to a desired height (approximately 15-25 feet above the ground), all while carrying the tree stand. Once at the desired height, the stand then had to be secured to the tree by wrapping a cable or chain around the tree and tightening it, all while standing on the ladder. As will be described in more detail, at least one advantage of the present invention is that it can be installed from the ground.

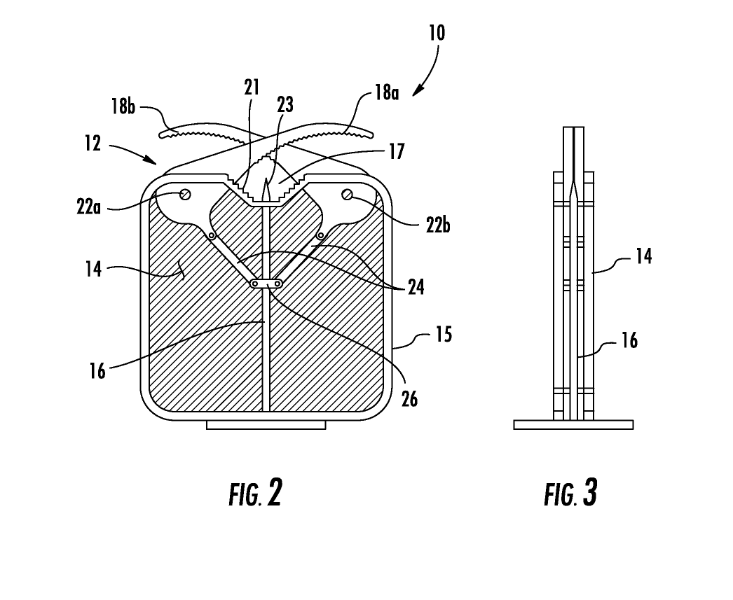

Referring to FIGS. 2 and 3, the present tree stand includes a platform or seating platform 14 formed from an outer peripheral frame 15, having a front, back and opposing sides, which define the shape of the platform 14. The frame 15, which can be most any suitable size and shape, is also the main structural member of the platform 14. The frame 15 should be constructed from a durable material which provides rigidity, lightness and strength to the platform 14. Likewise the main surface of the platform 14 can be constructed from any similar durable material, while maintaining the lightness and portability of the assembly. A seating assembly (not shown) can also be attached to the platform, where the user can sit once the assembly is in place. These seating assemblies are well-known in the art and would preferably attach to the platform 14 through the use of a swivel or swivels attachment, allowing for a variety of seating positions.

The back edge of the platform 14, which contacts the surface of the tree when the stand 10 is in position, includes an indented or cutout section 17 having a plurality of teeth 21. The teeth 21 assist in securing the stand 10 to the tree trunk and help prevent slipping. Optionally, a large spike 23 may be used for even greater retention of the stand 10 in place. However, conservation-minded individuals and some venues do not favor the use of any device that may cause permanent damage to trees.

Attached to the platform 14, preferably at the bottom surface, is safety system 12. The safety system is comprised of a centrally mounted rotatable threaded shaft 16, two movable securing members 18a, 18b, and linkage 20. The securing members 18a, 18b are linked to the threaded shaft via linkage 20 and pivotably secured to the platform 14 by pivots 22a, 22b. The linkage 20 for the illustrated embodiment is comprised of linking arms 24 and a traveler 26 which moves between the ends of the shaft 16 when it is rotated. Movement of the traveler 26 is accomplished via the threaded engagement between the exterior surface of the shaft 16 and the threaded opening of the traveler 26.

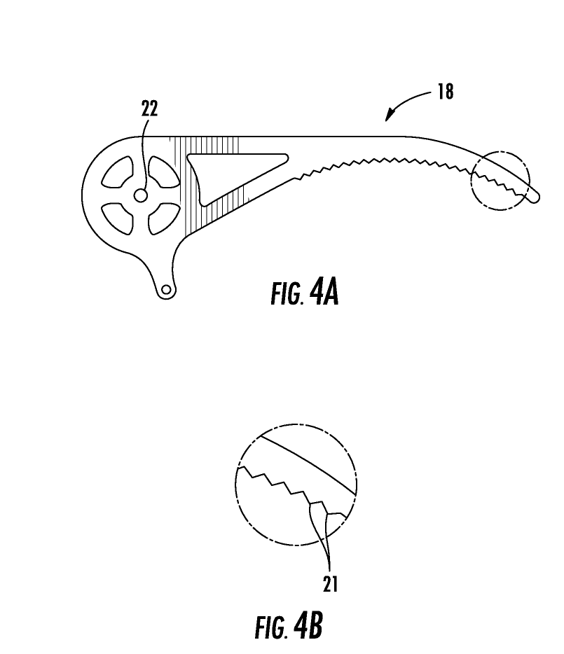

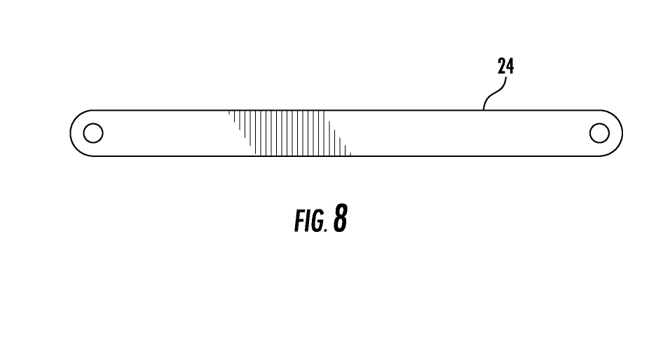

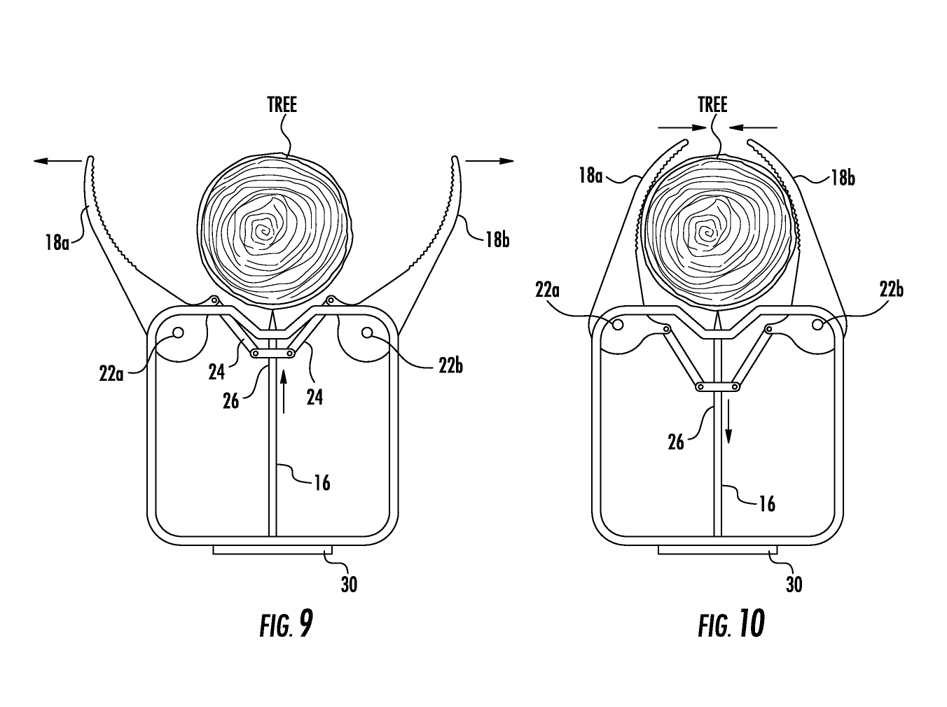

As shown in FIG. 2, the linking arms 24 are coupled to the traveler 26 and one of the two securing members 18. As the traveler 26 moves along the threaded shaft 16, the linking arms 24 push or pull at the connection point and cause the jaws portion (i.e., the toothed section; See FIG. 4) of each securing member 18 to pivot about the respective pivot 22a, 22b. As illustrated in FIGS. 9 and 10, movement of the traveler 26 in one direction pivots the securing members 18 outward, and movement in the opposite direction pivots the securing members 18 inward.

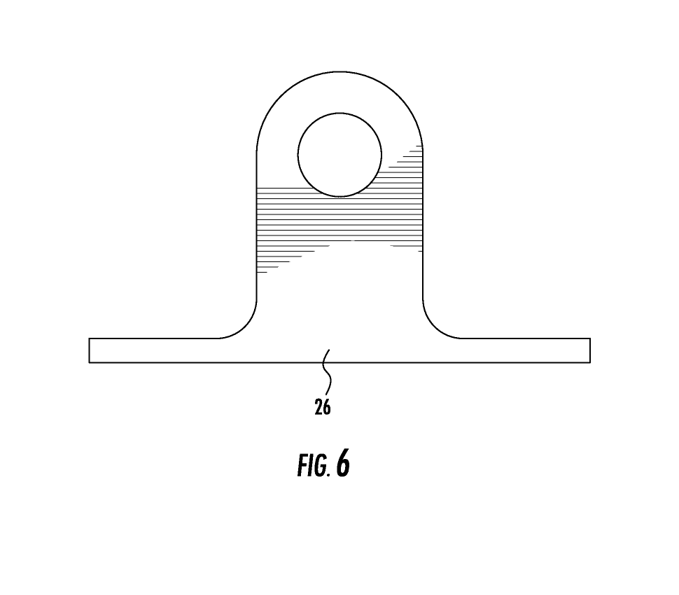

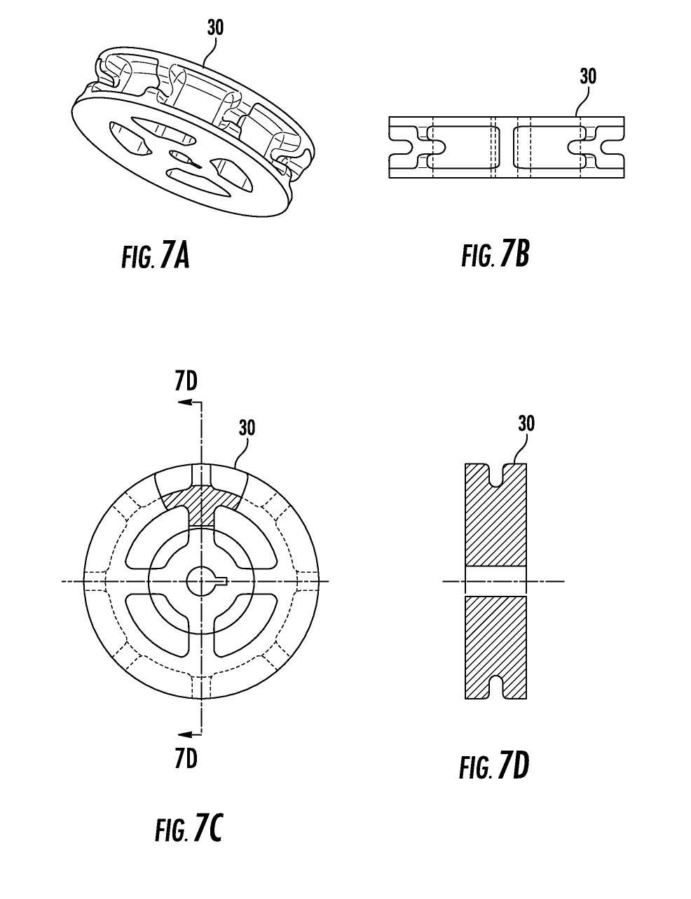

To facilitate rotation of the shaft 16, a gear 30 is fixed to an end of the shaft 16. While the gear 30 may be turned by hand, the intention is to couple a chain, cable or rope (FIG. 1) to the gear 30 to allow it to be rotated remotely. Accordingly, the gear 30 may be provided as a pulley (see FIG. 7) with a channel to allow frictional engagement with a length of material, such as a rope or cable. This feature works much like a chain-pull.

The safety system 12 is an important feature in the present tree stand 10. The illustrated longitudinal orientation (centered and extending front to back) of the rotatable shaft 16 is believed to work best, but a transverse (extending side to side) or even a diagonal orientation may be used with alternate linkage, as would be understood by those skilled in the art.

The securing members 18 preferably have an arcuate shape which best allow them to engage a curved surface, such as a tree trunk. To further enhance securing the platform 14 to the tree trunk, the inner surface of each securing member 18 includes a plurality of teeth 21, much like the teeth 21 on the back edge of the platform 14. When the securing members 18 are positioned and closed around the tree trunk, the teeth 21 are intended to engage the tree trunk without significant damage to the bark.

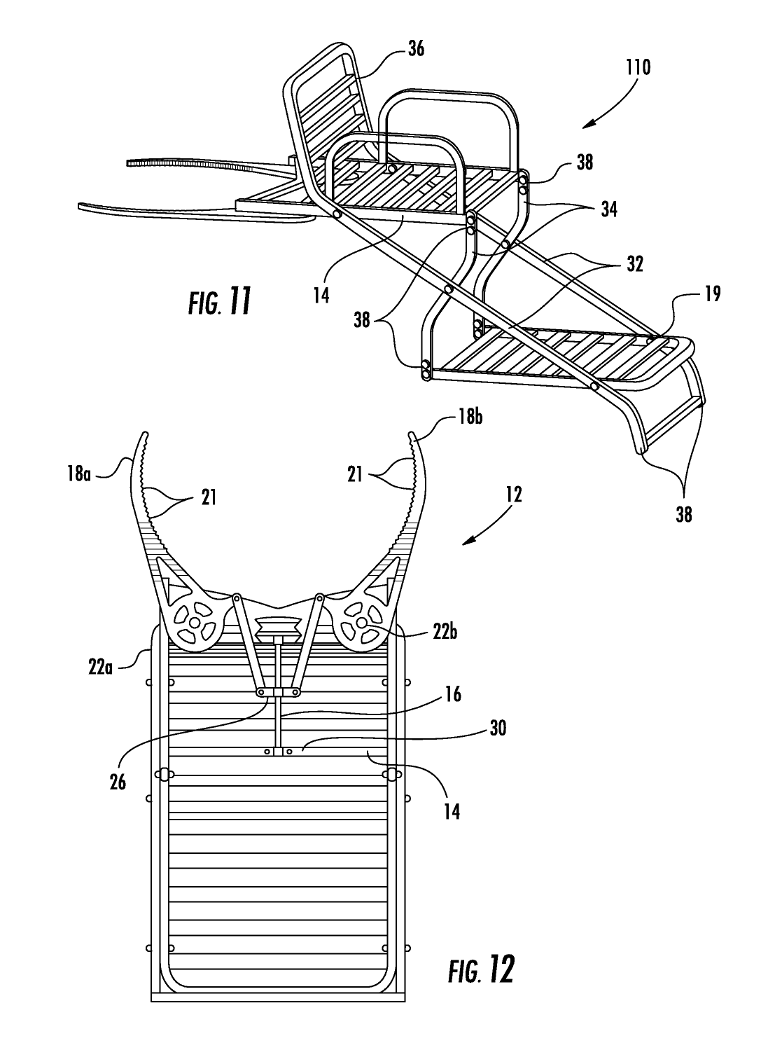

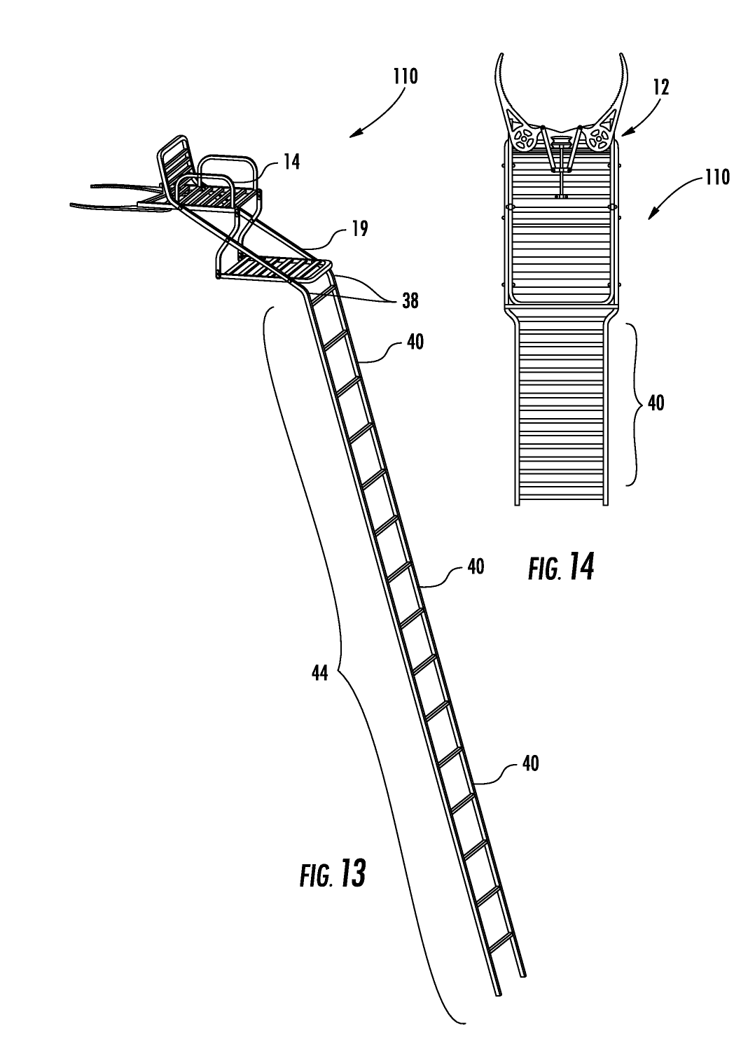

Looking at the embodiment of FIGS. 11 to 17, the tree stand 110 may be compactable to make transportation of the stand much easier. Much like the embodiment described above, the compact tree stand uses the safety system 12 attached to a first platform (or support surface) 14. Also, as shown in FIGS. 11 and 13, the compactable tree stand 110 includes a second platform 19. The second platform 19 is connected to the first platform 14 by two pair of connecting rails 32 and 34. The first pair of connecting rails 32 is attached to the side of the first platform 14 proximate the back edge and to the second platform 19 proximate the front edge. As shown, the first pair of connecting rails 32 includes a back support 36 at one end and connectors 38 at the other end, which is explained in further detail below. The back support 36 and connectors 38 are merely optional features which may not necessarily be included with all tree stands.

The second pair of connecting rails 34 is connected by a first end to the side edges of the first platform 14, proximate a front edge, and by a second end to the side edges of the second platform 19, proximate the back edge. The two pair of connecting rails, 32 and 34, cross proximate a midpoint where they are fastened together for stability. The connections of the second connecting rails 34 to the first platform 14 and second platform 19 are preferably releasable via removable pins 38, as is know in the art. The removal of the pins 38 allows the second platform 19 to pivot upward and connect, via overlapping flanges and reuse of the removed pins 38, to the front edge of the first platform 14 (see FIGS. 15-17).

The compactable tree stand 110 may also include an access member in the form of a plurality of ladder sections 40. The ladder sections 40, which may be any suitable length (e.g., 2-4 ft) can be made to connect end to end, or more preferably, unfolded (via hinges, not shown) into a ladder 44 for attachment to the connectors 38 of the first pair of connecting rails 32. Once attached, the ladder 44 allows the first platform 14 to be positioned at the desired height for attachment to a tree. The ladder 44 then provides access to and from the secured platform.

Installation and removal of the tree stand assembly is much safer than prior tree stands. For installation, the ladder 44 is unfolded and attached to the tree stand 10, which can then be lifted into position with the first and second securing members, 18a and 18b, in an open position (FIG. 9). When a suitable sturdy position is found with the open first and second securing members, 18a and 18b, around the tree trunk, the user can then begin to secure the stand 10. Using a chain, rope or other length of suitable material connected to the gear 30, a user positioned on the ground is able to pull the chain or rope to rotate the gear 30 in the appropriate direction, rotating the gear to turn the central shaft 16. Rotating the central shaft 16 moves the traveler 26, which in turn moves the linking arms, 24a and 24b, pivoting the first and second securing members, 18a and 18b, toward each other and toward the trunk of the tree. The toothed portion of the arcuate arm engages the tree and can be tightened significantly to secure the platform against the tree. Additional supports are not needed, but can be used for added peace-of-mind to the user. The ladder 44 can then be used to access the platform 14.

Removing the tree stand 10 follows a similar procedure to the above installation. From the ground, the user pulls the chain, which rotates the gear 30 and the central shaft 16 in a second direction. This rotation moves the traveler 26, causing the first and second securing members, 18a and 18b, to pivot away from each other, opening away from the tree trunk. The stand 10 can then be lowered from the tree position to be squared away.

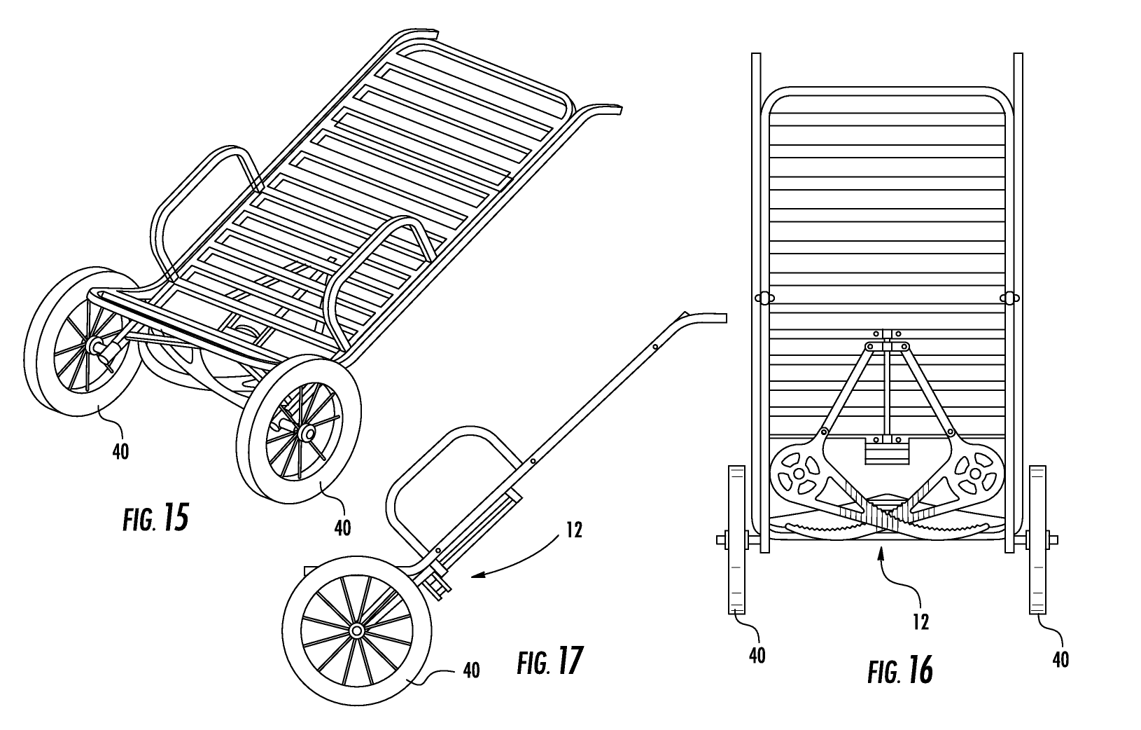

As a further option, wheel assemblies 40 can be attached to the side edges of the first platform 14 at the back edge, as shown in FIG. 16. These wheel assemblies 40 would need to be removable, so as not to interfere with the stand 10 being attached to a tree. However, ingress and egress to the tree stand erection site can be facilitated by the wheeled configuration. Further, with reference to FIGS. 15 and 17, the compacted stand 10 can be operated as a gear/game cart, allowing a significant load to be fastened to the connected first and second platforms, if necessary.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A portable tree-stand assembly comprising:
a platform having a top surface and a bottom surface and a periphery defined by an edge;
a rotatable shaft attached to a surface of the platform;
a first movable securing member positioned to extend beyond the periphery of the platform and coupled to the rotatable shaft through a pivoting linkage;
a second movable securing member positioned to extend beyond the periphery of the platform and also coupled to the rotatable shaft through the pivoting linkage; and
a gear fixed to the rotatable shaft for turning the shaft about a longitudinal axis, wherein when the gear rotates the shaft in a first direction, the first and second securing members are pivoted outward away from each other by the pivoting linkage, and when the gear rotates the shaft in a second direction, the first and second securing members are pivoted inward toward each other by the pivoting linkage.

2. The portable tree-stand assembly of claim 1, wherein the first securing member and the second securing member each comprise an arcuate-shaped arm for engaging a substantially round vertical structure.

3. The portable tree-stand assembly of claim 2, wherein the arcuate-shaped arm of each securing member comprises an inner contact surface having a plurality of teeth.

4. The portable tree-stand assembly of claim 1, further comprising a length of material engaged with the gear to allow remote rotation in both the first direction and the second direction by pulling on the material.

5. The portable tree-stand assembly of claim 1, wherein the rotatable shaft is threaded.

6. The portable tree-stand assembly of claim 5, wherein the pivoting linkage comprises:
a traveler for responsively engaging the threads of the rotatable shaft and moving along the rotatable shaft as it is turned by the gear,
a first arm connected by a first end to the traveler and by a second end to the first movable securing member, and
a second arm connected by a first end to the traveler and by a second end to the second movable securing member.

7. The portable tree-stand assembly of claim 1, further comprising a spike capable of attaching to the base of the tree-stand.

8. A safety system for securing a tree-stand having a base to a vertical structure, the safety system comprising:
a rotatable shaft having a longitudinal axis of rotation and capable of attachment to the base of the tree-stand;
a first movable securing member responsive to the rotatable shaft through pivoting linkage;
a second movable securing member responsive to the rotatable shaft through the pivoting linkage; and
a gear fixed to the rotatable shaft for turning the shaft about the longitudinal axis;
wherein, when the gear rotates the shaft in a first direction, the first and second securing members are pivoted inward toward each other by the pivoting linkage, and when the gear rotates the shaft in a second direction, the first and second securing members are pivoted outward away from each other by the pivoting linkage;
wherein when pivoted inward, the first movable securing member and the second movable securing member cooperate to clamp onto the vertical structure to secure the base at a desired height, and when pivoted outward, the first movable securing member and the second movable securing member release the vertical structure to remove the base from the secured height.

9. The safety system of claim 8, further comprising a chain engaged to and extending from the gear to allow rotation in both the first direction and the second direction.

10. The safety system of claim 8, wherein both the first and second movable securing members comprise teeth along an engagement surface.

11. The safety system of claim 8, wherein the rotatable shaft is threaded.

12. The safety system of claim 11, wherein the pivoting linkage comprises a traveler for responsively engaging the threads of the rotatable shaft and moving along the rotatable shaft as it is turned by the gear, a first arm connected by a first end to the traveler and by a second end to the first movable securing member, and a second arm connected by a first end to the traveler and by a second end to the second movable securing member.

13. The safety system of claim 8, further comprising a spike capable of attaching to the base of the tree-stand.

14. A compactable tree-stand comprising:
a first support surface having a front edge, a back edge and opposing side edges;
a second support surface having a front edge, a back edge and opposing side edges;
a first pair of connecting rails connected by first ends to the opposing side edges of the first support surface and by second ends to the opposing side edges of the second support surface proximate the front edge relative to the first ends; and
a second pair of connecting rails connected by first ends to the opposing side edges of the first support surface at the front edge via a first pair of removable pins and by second ends to the opposing side edges of the second support surface at the back edge via a second pair of removable pins;
wherein the first pair of connecting rails pivotably connect to the second pair of connecting rails proximate a midpoint, and
wherein the tree-stand is configured to be switched between an open configuration and a closed configuration, the open configuration being when the second pair of connecting rails are connected to the first and second support surfaces and the closed configuration being when the second pair of connecting rails are disconnected from the first and second support surfaces via the first pair and second pair of removable pins and the front edge of the first support surface is connected to the back edge of the second support surface.

15. The compactable tree-stand of claim 14, further comprising a safety system comprising:
a rotatable shaft having a longitudinal axis of rotation and capable of attachment to the first support surface;
a first movable securing member responsive to the rotatable shaft through pivoting linkage;
a second movable securing member responsive to the rotatable shaft through the pivoting linkage; and
a gear fixed to the rotatable shaft for turning the shaft about the longitudinal axis;
wherein, when the gear rotates the shaft in a first direction, the first and second securing members are pivoted inward toward each other by the pivoting linkage, and when the gear rotates the shaft in a second direction, the first and second securing members are pivoted outward away from each other by the pivoting linkage; and
wherein when pivoted inward, the first movable securing member and the second movable securing member cooperate to clamp onto a vertical structure to secure the first support surface at a desired height, and when pivoted outward, the first movable securing member and the second movable securing member release the vertical structure to remove the first support surface from the secured height.

16. The compactable tree-stand of claim 14, further comprising a pair of wheels which detachably connect to the first support surface.

17. The compactable tree-stand of claim 16, wherein the wheels detachably connect proximate the front edge of the first support surface.

18. The compactable tree-stand of claim 14, further comprising at least one ladder section detachably connected to the first pair of connecting rails.

19. The compactable tree-stand of claim 18, wherein the at least one ladder section comprises a pair of male connector which inserts into the second ends of the first pair of connecting rails.

20. The compactable tree-stand of claim 14, wherein the first support surface further comprises a backrest.
